(19) United States
(12) Patent Application Publication
(10) Pub. No.: US 2011/0217675 A1
(43) Pub. Date: Sep. 8, 2011

(54) SCREW TO FIX A PROSTHESIS ON A DENTAL IMPLANT, SURGICAL DRIVER, KIT AND TORQUE KEY (AS AMENDED)

(75) Inventor: Ramón Farré Berga, Lleida (ES)

(73) Assignee: Oriol FARRE BERGA, Lleida (ES)

(21) Appl. No.: 12/988,617

(22) PCT Filed: Apr. 23, 2009
(86) PCT No.: PCT/ES09/00220

§ 371 Date: May 24, 2011

(30) Foreign Application Priority Data
Apr. 24, 2008 (ES) P200801180

(51) Int. Cl. A61C 13/225

(52) U.S. Cl. 433/172

(57) ABSTRACT

Screw (100), surgical driver (400), kit and torque key (500) to fix a prosthesis (200) on a dental implant (300). The screw (100) has a pin comprising fixing means arranged to fix the screw (100) in the implant (300) in a detachable way; a head, to house the prosthesis (200). The head comprises a protruding area which is mostly spherical and has curved-concave meridional sunken areas (110) to receive a grip (410, 510) of a handling tool (400, 500) for the screw (100); with a latitude between ±80°, with respect to the equator (E) of the head. The surgical driver (400) has a work part comprising fastening means with a shape which combines with the shape of the head of the screw (100). The kit comprises the surgical driver (400), the screw (100) and a protective cap (450). The torque key (500) has a similar configuration to that of the surgical driver (400).

### FIELD OF THE INVENTION

The object of the present invention consists of a screw to fix prostheses on dental implants, the head of which enables to press it up to 30° inclinations with respect to the axis of said screw.

The tools which enable to perform these operations are also the object of the present invention, specifically, a torque wrench and a reusable surgical driver which allows for the screws to be sterile, not to be touched by any hands, dropped or lost when handled, and to have an anti-loose design.

### BACKGROUND OF THE INVENTION

The use of screws to fix prostheses in the field of dental implants, being said screws accessed to through channels of the dental prostheses. These screws usually have a connection or Allen hex head, and in order to insert them the wrench is inserted in the axis of the screw and the implant, limiting the cases of direct connection and needing more intermediate parts and more work. Likewise, to use them it is essential to hold them with the fingers first to insert the corresponding torque wrench and later insert them, watching that they do not fall, inside the prosthesis inserted in the mouth.

In order to place a prosthesis on a dental implant a screw is needed, which is screwed into the implant and which holds the prosthesis.

This screw is inserted through a hole of the prosthesis called channel and to avoid affecting the prosthesis aesthetics, said hole or channel has to be hidden by the buccal part of the prosthesis, that is to say, by the part which cannot be seen just by looking at it. The inclination of this channel, determined by the position in which the implant is placed, does not always have the best angulation for several causes (deficient bone, bad planning, among others).

If there is good angulation, it is possible to make a direct connection, that is to say, without intermediate elements; the screw is threaded through the prosthesis channel and said channel is carefully covered to have access to the screw in the future. The direct connection facilitates the dentist's and dental technician's work, since the lack of intermediate steps reduces the cost and makes it easier to extract the prosthesis for check-ups.

If there is not good angulation, it is possible to use a dynamic pillar (Max. 20°) or angled intermediate parts can be placed and on top of them a cemented prosthesis can be inserted which affects the aesthetics (more thickness) and hinders the extraction for check-ups (they can be broken when extracting them with a dental hammer), and they significantly increase the cost of the work.

Until now, in the case of a direct connection, the dentist takes the following steps: an Allen screw is threaded by hand, making it unsterile, the Allen torque wrench is inserted and carefully preventing it from falling, the screw is inserted through the channel of the prosthesis placed on top of the implant to finally push it. Up to now, it is possible to correct up to 20° using an appropriate wrench. The document 2.278.477 A1 shows a ball-top Allen wrench, very well-known in the hardware area.

However, the proposals known have the following inconveniences:
Unsterile screws, possible infections
Bad handling of the screw since it is very small and has to be held using gloves
Correction of only 20° of angulation
Problems with the torque wrench with the screw, since the screw can be blocked and the wrench may not be properly fitted
The screw head hexagon can be overtorqued
Few cases of direct connection

### DESCRIPTION OF THE INVENTION

The present invention comprises a screw to fix dental prostheses with a spherical knuckle-shaped head. Said knuckle has a plurality of grooves coinciding with the surgical driver and the torque wrench.

The head has the special feature of enabling the wrenches to act with an inclination of up to 30° with respect to the screw axis. In this way, the channel can have up to 30° of angulation with respect to the axis of the implant, thus enabling to correct most direct connection cases.

The screw also has an embossment under its head, in the area in contact with the prosthesis, which reduces the risk of getting loose.

The sterile reusable surgical driver can be applied with the screw and is easily removed when the threading is over.

Once the screw to fix the dental prosthesis is inserted with the help of the surgical driver it is threaded in the dental implant. Later, the surgical driver is removed and the desired pressure is exerted with the torque wrench mounted on the compatible dynamometric ratchet.

Thus, a first aspect of the invention refers to a screw to fix a prosthesis on a dental implant, wherein:
the prosthesis has:
   an external or exposed face oriented towards the exterior of the mouth;
   an internal or hidden face opposite the external or exposed face, comprising a channel, being the channel the cavity of the prosthesis through which the screw passes, which has a specific inclination determined by the position of the implant;
the screw has:
   a threaded pin or first end comprising fixing means arranged to fix the screw in the implant in a detachable way;
   a head, or second end opposite the first end, arranged to house the prosthesis.

In the screw of the invention:
the head comprises a protruding area which is mostly spherical and knuckle-shaped and has a plurality of sunken areas, flutes or curved-concave meridional grooves:
   arranged to receive a grip, clamp or tooth of a handling tool for the screw;
   with a latitude between ±80°, with respect to the equator of the head. This arrangement of the head of the screw enables it to be adapted with the end of the surgical driver and the torque wrench, which makes it possible to handle the screw through a channel located in a prosthesis with a 30° inclination with respect to the axis of the fixing screw.

The head can comprise a part which is seated on the dental implant and has a fluted radial protruding area with anti-loose characteristics.

Besides, the head can comprise a log-conic-shaped part which is seated on the dental implant.

Specifically, the screw can comprise between 2 to 10 sunken areas, although most frequently it has 6.

A second aspect of the invention refers to a surgical driver comprising:
a work part comprising:
   fastening means with a shape which combines with the shape of the head of the screw, the fastening means comprising:
      a housing with the shape of a mainly spherical cavity, having a larger diameter than the spherical protruding area of the screw to be fastened; a plurality of anchoring grips with the shape of a curved-concave protruding area, featuring flaps, hooks or tongues located in the equator of the housing, arranged to fit in the sunken areas; the surgical driver is similar to the torque wrench; the surgical driver is made of rigid plastic, allowing a closer fitting with the screw, which makes the screw more secured;
a handling part comprising a pin-shaped fix grip to form the handle of the surgical driver.

In the surgical driver of the invention:
the handling part can also comprise:
   opening and closing means to move the anchoring grips and the flaps between: a receiving position, in which the screw can be inserted between the anchoring grips and the flaps and; a fastening position, in which the screw is clasped by the anchoring grips and the flaps, opening and closing means comprising:
      the cap-shaped handling part located on the connecting part, arranged to be moved between: an open position, where the anchoring grips and the flaps are in a receiving position and; a closed position, where the anchoring grips and the flaps are in a fastening position;
the surgical driver also comprises a mechanism arranged for the handling part to be moved between the open and closed positions by a movement selected between sliding movement, rotating movement and combinations thereof.

The surgical driver can be reused to store the screw for each patient, since the screw is also reusable so that it can be sterilized at a patient's follow-up, stored and inserted again.

A third aspect of the invention refers to a kit of screw to fix a prosthesis on a dental implant comprising the previously described surgical driver and screw and a protective cap where the screw, and at least the work part of the surgical driver are encapsulated in a sterile environment.

A fourth aspect of the invention refers to torque wrench comprising:
a work part comprising:
   dragging means with a shape which combines with that of the head of the screw, the dragging means comprising:
      a housing with the shape of a mostly spherical cavity, having a larger diameter than the spherical protruding area of the screw to be fastened;
      a plurality of anchoring grips with the shape of a curved-concave protruding area, arranged to fit in the sunken areas;
a pin-shaped handling part to form a handle of the torque wrench;
a mandrel-shaped connecting part to form universal connecting means arranged to connect the torque wrench to a dentist's ratchet.

### BRIEF DESCRIPTION OF THE DRAWINGS

The following is a brief description of a series of drawings which will help understand the invention better clearly relating to an embodiment of said invention which is presented as a non-limiting example thereof.

FIG. 1 is a sectional drawing showing a prosthesis inserted on an implant with a screw held by a surgical driver.

FIG. 2A is a view of a surgical driver. FIG. 2B is a detailed view of the surgical driver, showing the work part where the housing and anchoring grips can be seen. FIG. 2C is a view of the surgical driver with a cap.

FIG. 3A is a view of a torque wrench. FIG. 3B is a detailed view of the torque wrench showing the work position where the housing and anchoring grips can be seen.

FIGS. 4A-4D show perspective, plant and elevated views of the screw.

FIG. 5 shows a perspective view of an embodiment variant of the work part of the torque wrench or surgical driver.

FIG. 6 shows a lateral elevation view of an embodiment variant of the head of the screw, to be operated with the work part of FIG. 5.

FIG. 7 shows the coupling between the work position of FIG. 5 and the head of the screw of FIG. 6.

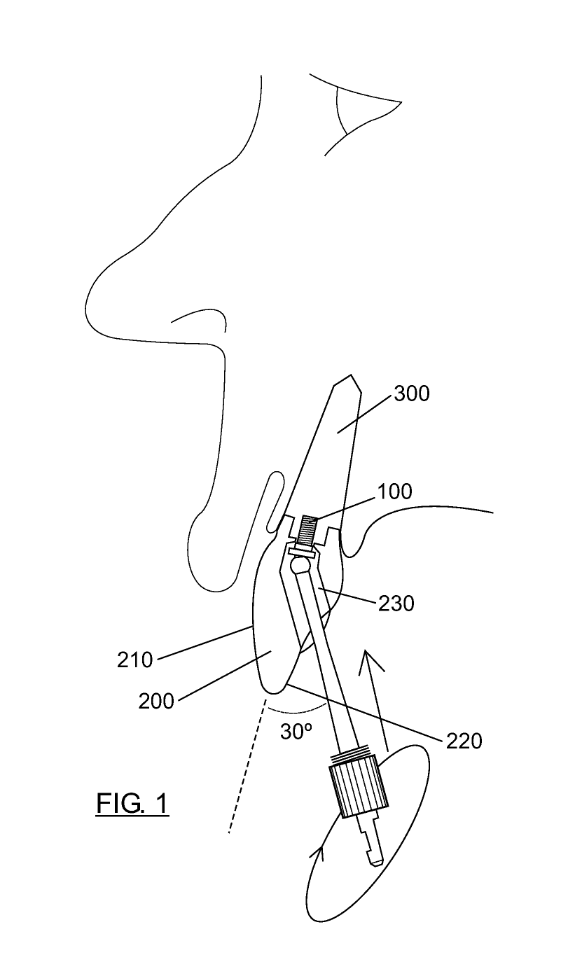

### DESCRIPTION OF A PREFERRED EMBODIMENT OF THE INVENTION A first embodiment of the invention refers to a screw (100) to fix a prosthesis (200) on a dental implant (300), wherein:

the prosthesis (200) has:
   an external or exposed face (210) oriented towards the exterior of the mouth; an internal or hidden face (220) opposite the external or exposed face (210), comprising a channel, being the channel the cavity of the prosthesis (200) through which the screw (100) passes, which has a specific inclination determined by the position of the implant (300);
the screw (100) has:
   a threaded pin or first end comprising fixing means arranged to fix the screw (100) in the implant (300) in a detachable way;
   a head, or second end opposite the first end, arranged to house the prosthesis (200).

In the screw (100) of the invention:
the head comprises a protruding area which is mostly spherical knuckle-shaped and has a plurality of sunken areas (110), flutes or curved-concave meridional grooves:
   arranged to receive a grip (410, 510), clamp or tooth of a handling tool (400, 500) for the screw (100);
   with a latitude between ±80°, with respect to the equator (100E) of the head.

This arrangement of the head of the screw (100) enables it to be adapted to the end of the surgical driver and the torque wrench, which enables to manipulate the screw (100) through a channel (230), located in a prosthesis with a 30° inclination with respect to the axis of the fixing screw.

The head comprises a part which is seated on the dental implant (300) and has a fluted radial protruding area with anti-loose characteristics.

Besides, the head comprises a log-conic-shaped part which is seated on the dental implant (300).

In a preferred embodiment of the invention, the screw (100) can comprise 6 sunken areas.

A second embodiment of the invention refers to a surgical driver (400) comprising:
a work part comprising:
   fastening means with a shape which combines with the shape of the head of the screw (100), the fastening means comprising:
      a housing (415) with the shape of a mainly spherical cavity, having a larger diameter than the spherical protruding area of the screw (100) to be fastened;
      a plurality of anchoring grips (410) with the shape of a curved-concave protruding area, featuring flaps, hooks or tongues (410A) located in the equator (400E) of the housing (415), arranged to fit in the sunken areas (110); the surgical driver is similar to the torque wrench; the surgical driver is made of rigid plastic, allowing a closer fitting with the screw, which makes the screw more secured;
a handling part comprising a pin-shaped fix grip (410) to form the handle of the surgical driver (400).

The fastening means which have anchoring grips (410) and the flaps, hooks or tongues (410A) can be made of rigid plastic.

The work part can also comprise a plurality of sunken areas (411) between the anchoring grips (410) for the surgical driver (400) to easily be inserted in the head of the screw (100).

In the surgical driver (400) of the invention:
opening and closing means to move the anchoring grips (410) and the flaps (410A) between: a receiving position, in which the screw (100) can be inserted between the anchoring grips (410) and the flaps (410A) and; a fastening position, in which the screw (100) is clasped by the anchoring grips (410) and the flaps (410A), said opening and closing means comprising:
   the cap-shaped handling part (430) located on the connecting part (420), arranged to be moved between: an open position, where the anchoring grips (410) and the flaps (410A) are in a receiving position and; a closed position, where the anchoring grips (410) and the flaps (410A) are in a fastening position;
the surgical driver (400) also comprises a mechanism arranged for the handling part (430) to be moved between the open and closed positions by a movement selected between sliding movement, rotating movement and combinations thereof.

The surgical driver (400) can be reused to store the screw for each patient, since the screw is also reusable so that it can be sterilized at a patient's follow-up, stored and inserted again. The surgical driver (400) can also have a thread (440) to hold fast the plastic cap (450) which encloses the work part and a screw (100).

A third aspect of the invention refers to a kit of screw (100) to fix a prosthesis (200) on a dental implant comprising the previously described surgical driver (400) and screw (100) and a protective cap (450) where the screw (100), and at least the work part of the surgical driver (400) are encapsulated in a sterile environment.

A fourth embodiment of the invention refers to torque wrench (500) comprising:
a work part comprising:
   dragging means with a shape which combines with that of the head of the screw (100), said dragging means comprising:
      a housing (515) with the shape of a mostly spherical cavity, having a larger diameter than the spherical protruding area of the screw (100) to be fastened;
      a plurality of anchoring grips (510) with the shape of a curved-concave protruding area, located in an equator (500E) of the housing (515) arranged to fit in the sunken areas (110);
a pin-shaped handling part (530) to form a handle of the torque wrench (500);
a mandrel-shaped connecting part (520) to form universal connecting means arranged to connect the torque wrench (500) to a dentist's ratchet.

The work part can also comprise openings (511A) in a plurality of grooves (511) between the anchoring grips (510) to facilitate the inserting of the torque wrench (500) in the head of the screw (100) in up to 30° angles.

In the embodiment shown in FIG. 6, the protruding part of the head of the screw 100 is surrounded at its base by a log-conic surface 120, on which there are stretched out nerves 130 separating the meridional sunken areas 110, by a decreasing section 140 and whose free end can have a beveled edge or inclined plane 150.

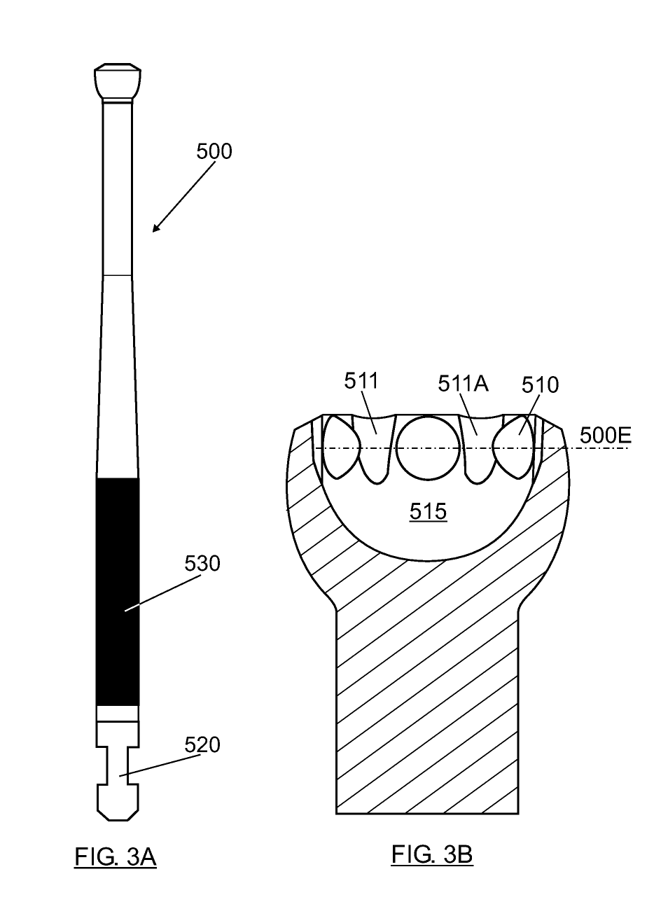

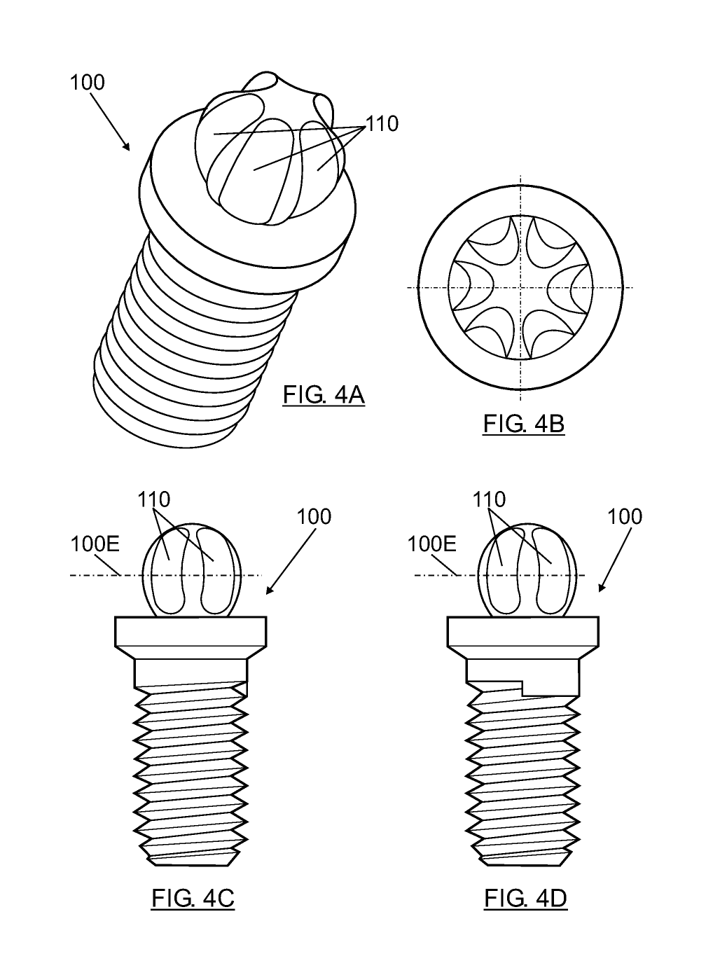

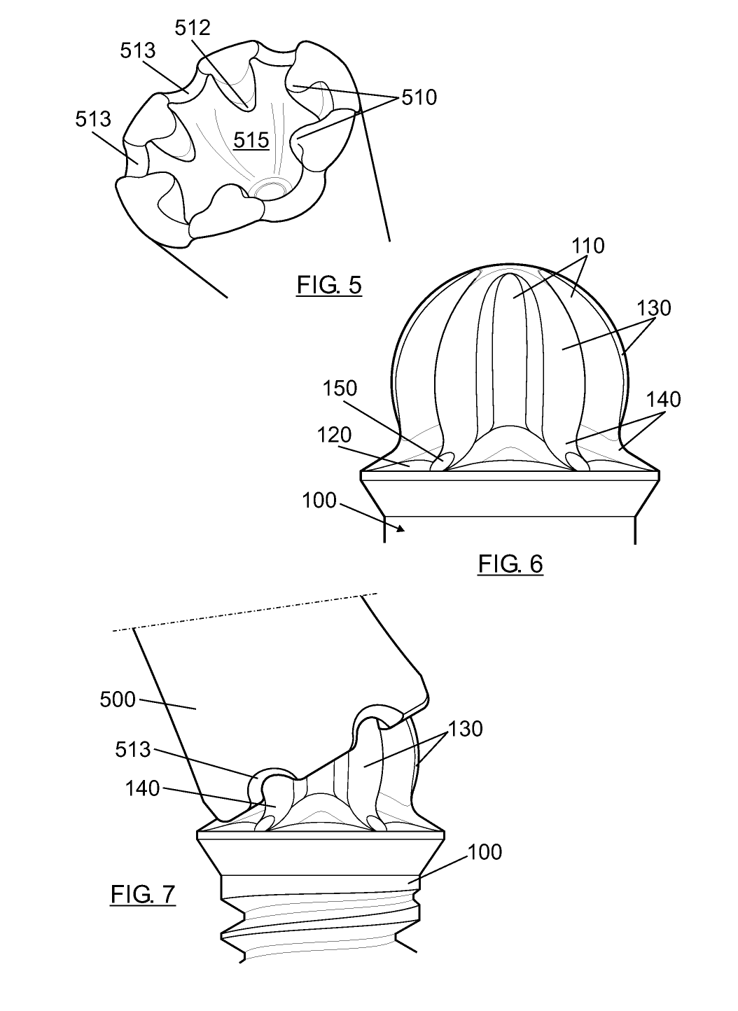

As regards the work part of the torque wrench, it will have the arrangement shown in FIG. 5, in which the grooves 511 of FIG. 3B are missing and the protruding parts which constitute the anchoring grips 510 extend inwardly in a section 512, which serves as reinforcement means of the tool, and reach the upper edge of the wall limiting the housing 515. Besides, this wall features, in positions altered with anchoring grips 510, recesses 513, with a curved-concave outline, which are coupled on the sections 140 of the nerves 130, as shown in FIG. 7, given more security to the performance of the screw 100 through the torque wrench 500.

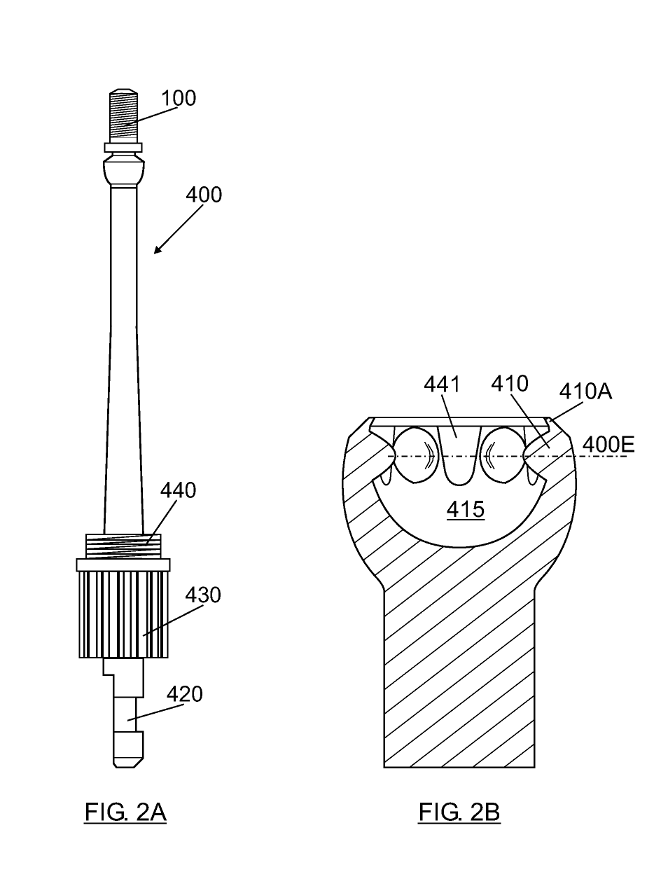

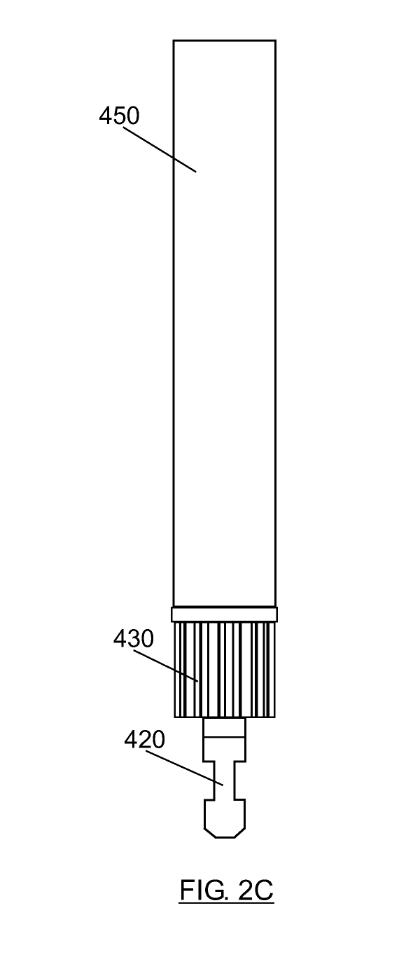

The same configuration of FIG. 5 can be applied to the work part of the surgical driver, shown in FIG. 2B.

1. A screw to fix a prosthesis on a dental implant, wherein:
the prosthesis has:
an external face towards the exterior of the mouth;
an internal face opposite the external or exposed face, comprising a channel, which has a specific inclination determined by the position of the implant;
the screw has:
a pin comprising fixing means arranged to fix the screw in the implant in a detachable way;
a head, arranged to house the prosthesis;
wherein
the head comprises a protruding area which is mostly spherical and knuckle-shaped and has a plurality of curved-concave meridional sunken areas:
arranged to receive a grip of a handling tool for the screw;
with a latitude between ±80°, with respect to the equator of the head.

2. Screw to fix a prosthesis on a dental implant according to claim 1 wherein the head comprises a part which is seated on the dental implant and has a fluted radial protruding area with anti-loose characteristics.

3. Screw to fix a prosthesis on a dental implant according to claim 1, wherein the head comprises a log-conic-shaped part which is seated on the dental implant (300).

4. Screw to fix a prosthesis on a dental implant according to claim 1, wherein comprises 6 sunken areas.

5. A surgical driver wherein it comprises:
a work part comprising:
fastening means with a shape which combines with the shape of the head of the screw, the fastening means comprising:
a housing with the shape of a mainly spherical cavity, having a larger diameter than the spherical protruding area of the screw to be fastened;
a plurality of anchoring grips with the shape of a curved-concave protruding area, featuring flaps located in the equator of the housing, arranged to fit in the sunken areas;
a handling part comprising a pin-shaped fix grip to form the handle of the surgical driver;
a mandrel-shaped connecting part to form universal connecting means arranged to connect the surgical driver to a dentist's ratchet.

6. A surgical driver according to claim 5 wherein:
the handling part comprises:
opening and closing means to move the anchoring grips and the flaps between: a receiving position, in which the screw can be inserted between the anchoring grips and the flaps and; a fastening position, in which the screw is clasped by the anchoring grips and the flaps, said opening and closing means comprising:
the cap-shaped handling part located on the connecting part, arranged to be moved between: an open position, where the anchoring grips and the flaps are in a receiving position and; a closed position, where the anchoring grips and the flaps are in a fastening position;
the surgical driver also comprises a mechanism arranged for the handling part to be moved between the open and closed positions by a movement selected between sliding movement, rotating movement and combinations thereof.

7. Kit of screw to fix a prosthesis on a dental implant wherein it comprises the surgical driver of claim 5, the screw and a protective cap where the screw and at least the work part of the surgical driver are encapsulated in a sterile environment.

8. A torque key, wherein it comprises:
a work part comprising:
dragging means with a shape which combines with that of the head of the screw, the dragging means comprising:
a housing with the shape of a mostly spherical cavity, having a larger diameter than the spherical protruding area of the screw to be fastened;
a plurality of anchoring grips with the shape of a curved-concave protruding area, located in a equator of the housing, arrange to fit in the sunken areas;
a pin-shaped handling part to form a handle of the torque key;
a mandrel-shaped connecting part to form universal connecting means arranged to connect the torque key to a dentist's ratchet.

9. Screw to fix a prosthesis on a dental implant according to claim 1 the nerves which separate the meridional sunken areas stretch out radially on the surface surrounding the base of the protruding part of the head of the screw in decreasing sections.

10. Torque key according to claim 8, wherein the anchoring grips extend inwardly in a reinforcement section, and in that the wall limiting the housing features recesses, which can be coupled on the sections of the screw.
